(19) United States
(12) Patent Application Publication
(10) Pub. No.: US 2002/0038223 A1
(43) Pub. Date: Mar. 28, 2002

(54) Apparatus, method and program for creating information to be provided

(76) Inventors: Ryo Niitsuma, Yokohama-shi (JP); Hiroaki Kotabe, Sashima-gun (JP)

Correspondence Address: Alex Chartove, Morrison & Foerster LLP, Suite 5500, 2000 Pennsylvania Avenue, N.W., Washington, DC, 20006-1888, US

(21) Appl. No.: 09/961,309

(22) Filed: Sep. 25, 2001

(30) Foreign Application Priority Data
Sep. 28, 2000 (JP) 2000-296735

(51) Int. Cl. G06F 17/60

(52) U.S. Cl. 705/1

(57) ABSTRACT

A storage unit of a Web page creator stores real estate information provided from a real-estate information center storing information regarding real estate, and stores also template data for a Web page to be showing the real estate information. A controller of the Web page creator creates a Web page to be showing predetermined real estate information, by incorporating the predetermined real estate information in the template data stored in the storage unit. The controller creates a plurality of Web pages in a hierarchical structure. The storage unit stores linking information for providing linking relationship between high and low levels of the hierarchical structure. The controller automatically creates the entire Web pages included in the hierarchical structure, using the linking information stored in the storage unit.

### BACKGROUND OF THE INVENTION

1. Field of the Invention

The present invention relates to an apparatus, method, and program for creating Web pages for showing predetermined information to be provided.

2. Description of the Related Art

Recently, real estate information (representing real estate, homes, apartments, etc.) can be registered and searched using a network on the Internet.

Many real estate companies have their company Web site, and show real estate information on their Web site to the public. For those real estate companies, showing such information on their Web site is useful for sales promotion.

Search engines, such as “Yahoo”, “Infoseek”, etc. provide a list of Web sites regarding real estate information that match user criteria and conditions, and hence having a great influence on the deals for immovable property.

On a day-to-day basis, the dealing context, including cancellation or contract, of immovables for rent or sale is updated. Hence, in accordance with the updated information of the dealing context, the real estate information to be shown on Web pages needs to be changed, corrected, deleted, and such.

Usually, the real estate information to be shown on Web pages is manually updated by an operator of a computer. Specifically, a person who is in charge of creating Web pages adds, changes, correct and delete information in(to) the real estate information, using a computer. The person visually checks prepared real-estate information (data), and directly inputs the checked information using a keyboard, or the like. Thus, the creating and maintenance of Web pages require a great amount of work force.

It would be too costly to order a specialized company for the creation and maintenance of Web pages.

Further, as explained above, if the Web pages are manually created and maintained by the person in charge of that, he/she may unintentionally make a mistake in inputting the real estate information.

### SUMMARY OF THE INVENTION

It is accordingly an object of the present invention to provide an apparatus, method and program for easily creating Web pages for showing information to be provided.

In order to achieve the above object, according to the first aspect of the present invention, there is provided a to-be-provided information creator, which creates at least one Web page showing at least one piece of real estate information to be provided through a network, said creator comprising:

a memory which stores the at least one piece of real estate information and at least one template for the at least one Web page; and

a page maker which creates the at least one Web page, by incorporating the at least one piece of real estate information stored in said memory into the at least one template stored in said memory.

According to this invention, Web pages can easily be created.

The memory may store a plurality of pieces of real estate information including the at least one piece of real estate information; and

said page maker may incorporate two or more pieces of real estate information included in the plurality of pieces of real estate information, into the at least one template, in such a manner that the plurality of pieces of real estate information are successively displayed in a list form on a single Web page.

The memory may store a plurality of pieces of real estate information including the at least one piece of real estate information and a plurality of templates including the at least one template, and said creator may further include:

a template selector which selects the at least one template for the at least one Web page, from the plurality of templates stored in said memory, in response to a request from a user of said to-be-provided information creator; and

an information selector which selects the at least one piece of real estate information from the plurality of pieces of real estate information stored in said memory, in response to a request from the user, and

wherein said page maker incorporates the at least one piece of real estate information selected by said information selector, into the at least one template selected by said template selector.

The at least one Web page to be created by said page maker may include a plurality of Web pages in a hierarchical structure;

said memory may store linking information for providing a linking relationship between high and low levels of the hierarchical structure; and

said page maker may create all Web pages included in the hierarchical structure, using the linking information.

The to-be-provided information creator may further include:

an information retriever which retrieves real estate information shown on another Web page, from the another Web page through a network; and

an information storage unit which stores the information retrieved by said information retriever in said memory.

In order to achieve the above object, according to the second aspect of the present invention, there is provided a method for creating at least one Web page showing at least one piece of real estate information to be provided through a network, said method comprising the steps of:

storing the at least one piece of real estate information and at least one template for the at least one Web page; and

creating the at least one Web page showing, by incorporating the at least one piece of real estate information into the at least one template.

The storing step may include a step of storing a plurality of pieces of real estate information including the at least one piece of real estate information; and

said creating step may include a step of incorporating two or more pieces of real estate information included in the plurality of pieces of real estate information, into the at least one template, in such a way that the plurality of pieces of real estate information are successively displayed in a list form on a single Web page.

The storing step may include a step of storing a plurality of pieces of real estate information including the at least one real estate information and a step of storing a plurality of templates including the at least one template, and said method may further include the steps of:

selecting the at least one template for the at least one Web page from the plurality of templates, in response to a request from a user; and

selecting the at least one piece of real estate information from the plurality of pieces of real estate information, in response to a request from the user, and

wherein said creating step includes a step of incorporating the selected at least one piece of real estate information into the selected at least one template.

The at least one Web page to be created may include a plurality of Web pages in a hierarchical structure;

said method may further include a step of storing linking information for providing a linking relationship between high and low levels of the hierarchical structure; and

said creating step may include a step of creating all Web pages included in the hierarchical structure, using the linking information.

The method may further include the steps of:

retrieving a piece of real estate information shown on another Web page, from the another Web page through a network; and

storing the retrieved information.

In order to achieve the above object, according to the third aspect of the present invention, there is provided a program for controlling a computer to function as

a to-be-provided information creator which creates at least one Web page showing at least one piece of real estate information to be provided through a network, and said creator comprising:

a memory which stores the at least one piece of real estate information and at least one template for the at least one Web page; and

a page maker which creates the at least one Web page by incorporating the at least one piece of real estate information stored in said memory, into the at least one template.

### BRIEF DESCRIPTION OF THE DRAWINGS

The object and other objects and advantages of the present invention will become more apparent upon reading of the following detailed description and the accompanying drawings in which:

FIG. 1 is a diagram showing the structure of a real-estate information system according to an embodiment of the present invention;

FIG. 2 is a diagram showing a hierarchical structure of a group of Web pages created by a Web-page creator included in the real-estate information system of FIG. 1;

FIG. 3 is a diagram showing a top page included in the group of Web pages shown in FIG. 2;

FIG. 4A is a diagram showing a search page for buying/selling, included in the group of Web pages of FIG. 2, FIG. 4B is a diagram showing a search page for rentals, included in the group of Web pages of FIG. 2; and FIG. 4C is a diagram showing a Web page for company information;

FIG. 5 is a diagram showing a listing page included in the group of Web pages of FIG. 2;

FIG. 6 is a diagram showing a detail description page included in the group of Web pages of FIG. 2;

FIGS. 7A and 7B are diagrams each showing a template for Web pages;

FIG. 8 is a diagram showing a template-setting display screen for setting a template for Web page; and

FIG. 9 is a flowchart showing a Web-page editing process which is carried out by a controller included in the Web page creator included in the real-estate information system of FIG. 1.

### DETAILED DESCRIPTION OF THE PREFERRED EMBODIMENT

A real-estate information system according to an embodiment of the present invention will now be described with reference to the accompanying drawings.

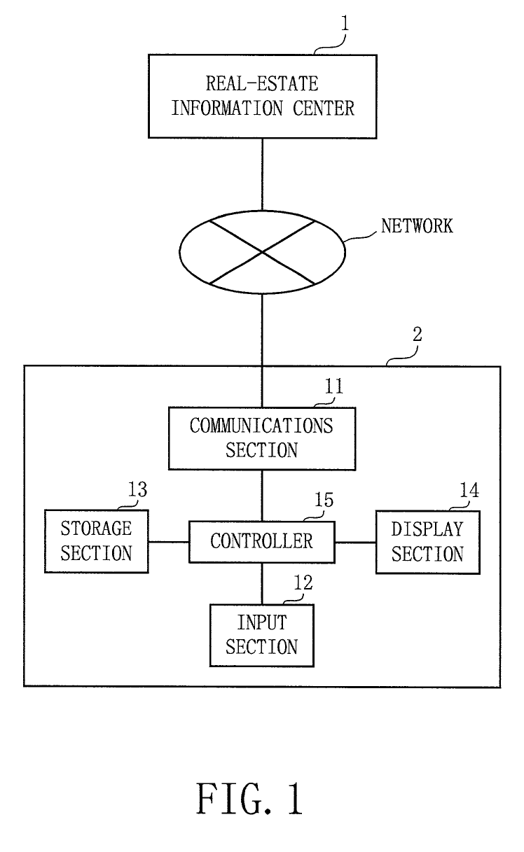

The real-estate information system according to the embodiment of the present invention comprises a real-estate information center 1 and at least one Web page creator 2, as illustrated in FIG. 1. In FIG. 1, only one Web page creator 2 is illustrated by way of example.

The real-estate information center 1 stores information (data) regarding real estate, for rentals and buying/selling, which are provided from a plurality of real estate companies. In response to a request from the Web page creator 2, the real-estate information center 1 provides the Web page creator 2 with stored data.

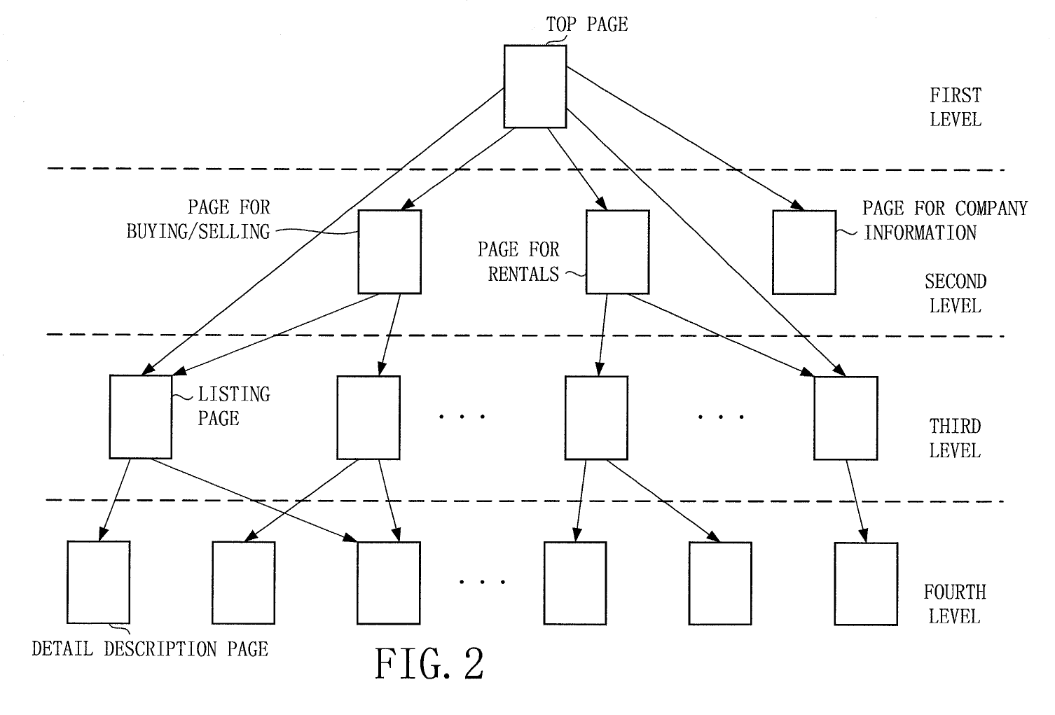

Each of the Web page creator 2 is installed in the real estate companies, etc. The Web page creator 2 creates a group of Web pages showing real estate information. The group of Web pages is in a hierarchical structure, as shown in FIG. 2. Note that the hierarchical structure of the group of Web pages, i.e. the linking relationship between high and low levels of the Web pages, is set by a user, etc. of the Web page creator 2.

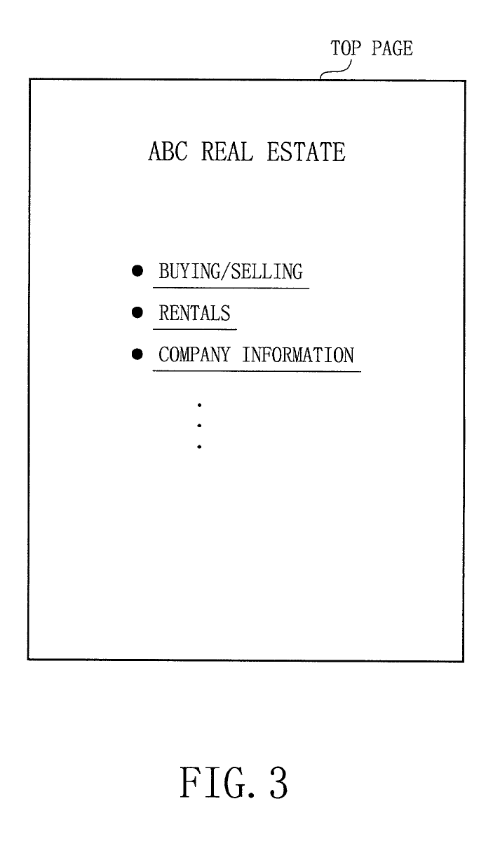

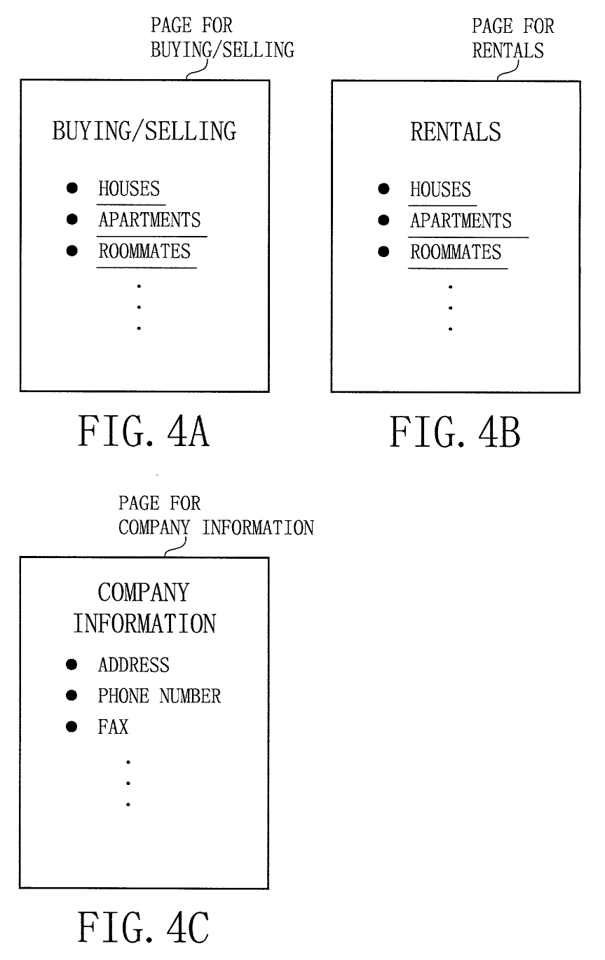

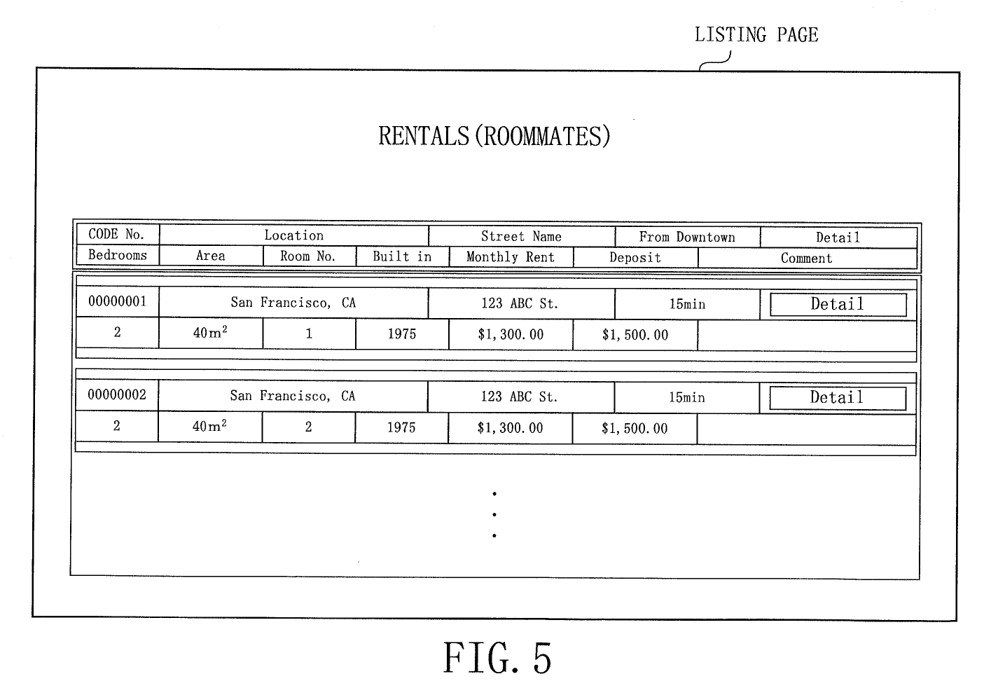

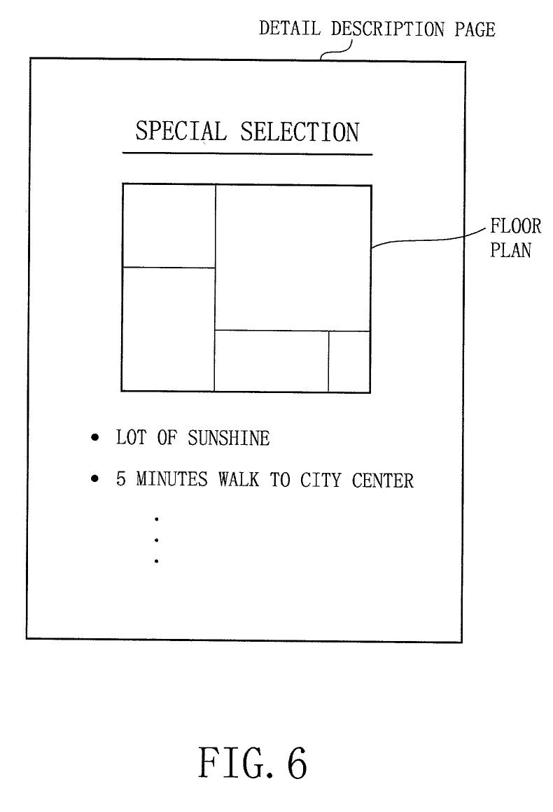

Specifically, the top page which is shown in FIG. 3 is set at the first level of the hierarchical structure. Set at the second level of the hierarchical structure are a search page for buying/selling, a search page for rentals, and a Web page for company information, which are shown respectively in FIGS. 4A, 4B, and 4C. Set at the third level of the hierarchical structure are listing pages, an example of which is shown in FIG. 5. Set at the fourth level of the hierarchy are detail description pages, each of which shows detail information of an apartment or house to be searched, as shown in FIG. 6.

The structure of the Web page creator 2 will now specifically be explained.

As shown in FIG. 1, the Web page creator 2 comprises a communications section 11, an input section 12, a storage section 13, a display section 14, and a controller 15.

The communications section 11 is connected to a network, such as the Internet, LAN (Local Area Network), etc., and controls data communications to be performed between the Web page creator 2 and any devices or apparatuses, connected to the Web page creator 2 through the network. For example, the communications section 11 is connected to the real-estate information center 1 through the network, and encodes and decodes data to be transmitted between the Web page creator 2 and the real-estate information center 1.

The input section 12 includes a keyboard, mouse, etc., and is operated by the user of the Web page creator 2. The input section 12 outputs various signals to the controller 15, in accordance with the operation of the user.

The storage section 13 includes a RAM (Random Access Memory), ROM (Read Only Memory), etc. The storage section 13 stores programs and data necessary for creating Web pages. For example, the storage section 13 stores linking information representing the linking relationship between the Web pages included in the group of Web pages and also information (data), etc., to be shown on the Web pages, and stores also template data (data of templates for Web pages).

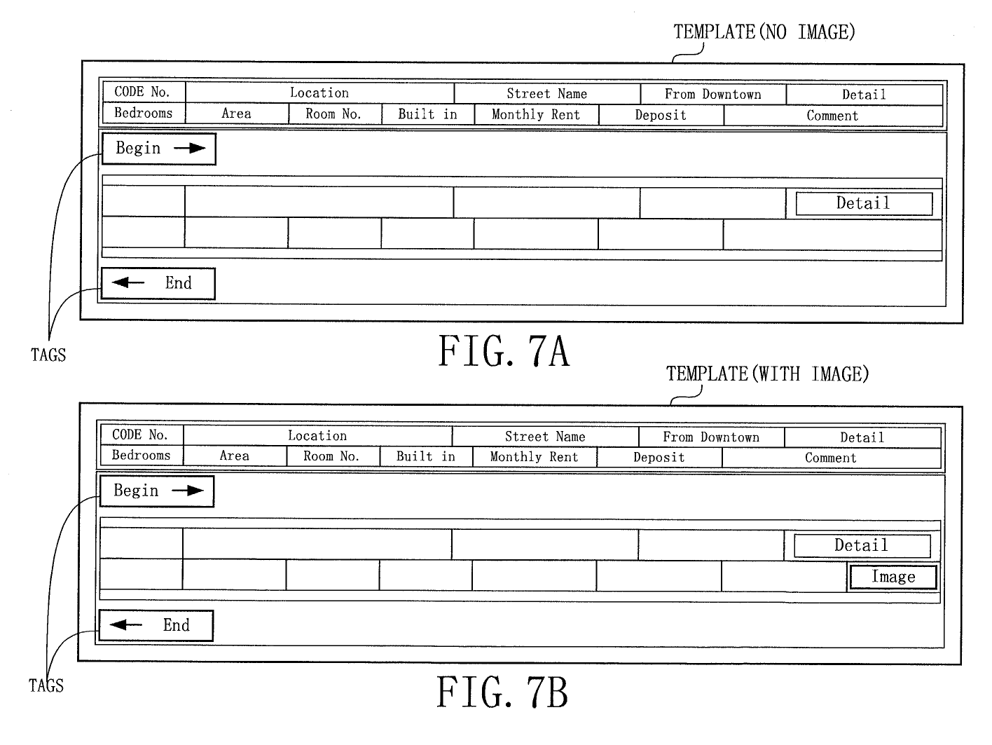

Various templates for Web pages may have different (various) arrangement of displayable contents and presentation of displayable image(s). For example, the template shown in FIG. 7A does not include the presentation of image, while the template shown in FIG. 7B includes the presentation of image. The above template data includes also data regarding table tags for use in Web pages. In addition, the header, footer, and other decorative graphics, etc. are selected in the template.

Shown on the Web pages are real-estate information and information regarding a real-estate company having the Web page creator 2, etc. The real-estate information includes “own information” representing apartments, houses, real estate, etc., managed by the real-estate company having the Web page creator 2 and “other-company information” representing apartments, houses, real estate, etc., managed by other real-estate companies. The “own information” is created by the real-estate company having the Web page creator 2, whereas the “other-company information” is provided from the real-estate information center 1. Each of the Web pages shows information representing a condition, etc. specified by the user of the Web page creator 2. As illustrated in FIGS. 7A and 7B, the template for the listing page includes tags each indicating the beginning or end of real-estate information included in the listing page. The target piece of real estate information to be shown on a Web page is inserted between the tags. In this structure, as shown in FIG. 5, following the item names indicating items included in each piece of real estate information, plural pieces of real estate information are listed and shown on the Web page.

The display section 14 includes a CRT (Cathode Ray Tube) or LCD (Liquid Crystal Display), and displays various setting display screens for creating Web pages.

The controller 15 controls operations of the Web page creator 2 in accordance with the programs and data, etc., stored in the storage section 13, to create a predetermined Web page. Operations of the controller 15 will be described in more detail later.

Operations of the Web page creator 2 having the above structure will now be described.

Let it be assumed that the information (real estate information and company information) shown on each Web page is stored in advance in the storage section 13 of the Web page creator 2.

When creating a Web page, the Web page creator 2 prepares a section corresponding to a Web site on WWW (World Wide Web). The Web site includes the Web page to be created and uploaded.

The Web page creator 2 sets a template for use in creating each Web page included in the group of Web pages.

Subsequently, the Web page creator 2 sets information to be shown on each Web page.

After this, the Web page creator 2 creates each of the Web pages by incorporating the set information in the template, and uploads thus created Web pages onto a predetermined server.

### (1) Set Template

Explanations will now be made to a process performed in the case where templates for creating the group of Web pages are set.

The user of the Web page creator 2 operates the input section 12 in accordance with predetermined procedures, to activate programs for creating Web pages. Upon this, the controller 15 activates the programs for creating Web pages which are stored in the storage section 13. The controller 15 creates Web pages in accordance with the programs and data stored in the storage section 13.

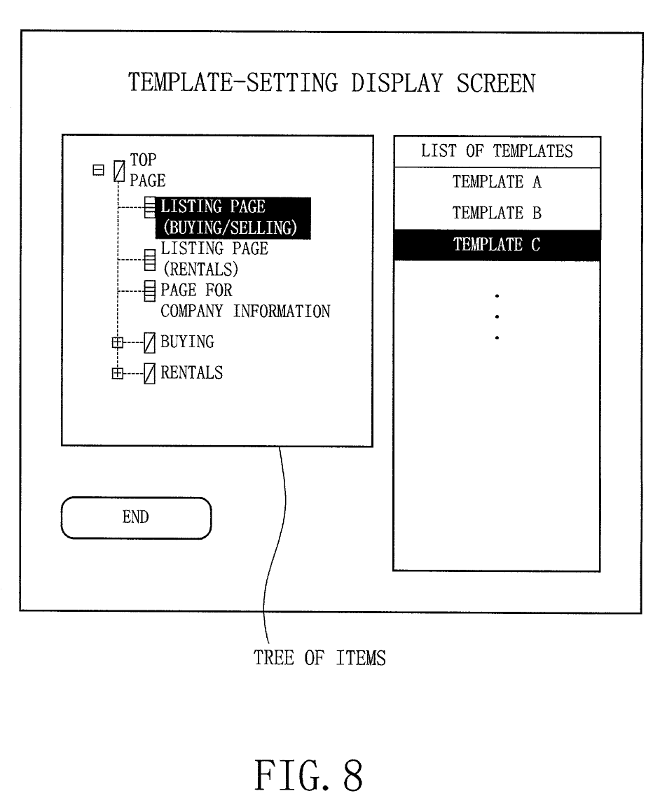

The controller 15 controls the display section 14 to display a template-setting display screen, shown in FIG. 8. On this display screen, the user can select a desired template for creating each of Web pages. As shown in FIG. 8, the template-setting display screen shows items, each of which corresponds to a Web page included in the group of Web pages. The items shown on the template-setting display screen are displayed in a tree corresponding to the hierarchical structure of the group of Web pages represented by the linking information stored in the storage section 13. The template-setting display screen includes also an “End” button for informing the controller 15 that the user has selected a template for each Web page to be created.

The user operates the input section 12, selects one target item, from the tree displayed on the template-setting display screen.

The controller 15 displays a list of usable templates for creating a Web page corresponding to the user-selected item, on the template-setting display screen, in accordance with the user's selection.

The user controls the input section 12, and selects a template for use in creating the selected Web page, from the displayed list of templates. At this time, the user may add a new template which is created using a predetermined tool, delete or make a change in any of the listed templates.

The controller 15 identifies the user-selected template based on signals sent from the input section 12. The controller 15 stores information representing the Web page corresponding to the user-selected item and the user selected template in association with each other, in the storage section 13, as template-selection information.

After this, the user sequentially performs the selection of a template for each page included in the group of Web pages, likewise the above. Then, the template-selection information regarding the group of Web pages are stored in the storage section 13.

The user operates the input section 12, and presses the “End” button prepared in the template-setting display screen, so as to complete the selection of the template.

Upon this, the controller 15 can detect that the selection of the template is completed. The controller 15 sets the user-selected template selected for each page included in the group of Web pages, as a template for use in creating the Web page.

Accordingly, the template for each Web page included in the group of Web pages is set. As described above, the template for each Web page is set in accordance with the linking relationship between the Web pages specified by the linking information stored in the storage section 13. Thus the templates can be set for all necessary Web pages.

### (2) Set Information To Be Shown

Explanations will now be made a process for setting information to be shown on each Web page included in the group of Web pages.

Upon completion of the setting of the template, the controller 15 of the Web page creator 2 controls the display section 14 to display a shown-information setting display screen. On this display screen, the user can select information to be shown on each of the Web pages.

Likewise the template-setting display screen, the shown-information setting display screen shows items indicating each Web page. The items are displayed in a tree corresponding to the hierarchical structure specified by the linking information stored in the storage section 13. The shown-information setting display screen includes an “End” button for informing the controller 15 that the user has selected to-be-shown information.

The user operates the input section 12, and selects an item from the tree displayed on the shown-information setting display.

In the case where the user selects an item corresponding to any one of the top page at the first level of the hierarchy, the search pages for apartment and for houses and a Web page for company information which are at the second level of the hierarchy, the controller 15 controls the display section 14 to display an input display screen for inputting information to be shown on a Web page corresponding to the user-selected item.

The user operates the input section 12, and inputs, in the displayed input display screen, information to be shown on the top page, search pages, or page for company information.

The controller 15 identifies the information input by the user based on signals sent from the input section 12. The controller 15 stores the information representing the Web page selected by the user and the information input by the user in association with each other, in the storage section 13 as input information data.

In the case where the user selects an item corresponding to the listing page which is at the third level of the hierarchy, the controller 15 controls the display section 14 to display an input screen for inputting listing condition(s) for setting information to be listed on the selected listing page.

In addition to the “own information”, the information to be shown on the listing page includes a large amount of “other-company information” sent from the real-estate information center 1. If the user specifies one or more listing conditions, the number of information pieces to be shown on the listing page can be limited, and thus restricting the data amount of the listing page.

The user operates the input section 12, and inputs listing conditions (city, monthly payment, number of bedroom(s), etc.) for setting information to be shown on the selected listing page.

The controller 15 identifies the input conditions based on signals sent from the input section 12. The controller 15 stores the information representing the user-selected listing page and the listing conditions input by the user in association with each other, in the storage section 13 as listing condition data. Then, the information to be shown on the user-selected listing page is set.

The information to be shown on the detail description page at the fourth level of the hierarchy is detail information of the real-estate information to be shown on the listing page at the third level of the hierarchy. Hence, the information to be shown on the listing page at the third level of the hierarchy is set, thereby to automatically set information to be shown on the detail description page at the fourth level of the hierarchy.

After this, likewise the above, the user sequentially inputs the information to be shown on or listing conditions for displaying the information on each Web page included in the group of Web pages. Then, the information to be shown on the group of Web pages is thus set.

To complete the setting of the to-be-shown information, the user operates the input section 12, and presses the “End” button included in the shown-information setting display screen. Upon this, the controller 15 can detect that the setting of the to-be-shown information is completed.

Accordingly, the information to be shown on each Web page included in the group of Web pages is set. As described above, because the information to be shown on each Web page is set in accordance with the linking relationship between the Web pages specified by the linking information stored in the storage section 13, the to-be-shown information can be set for all of the Web pages included in the group of Web pages.

### (3) Incorporate Data

Explanations will now be made to a process in the case where the set information is incorporated into the set template.

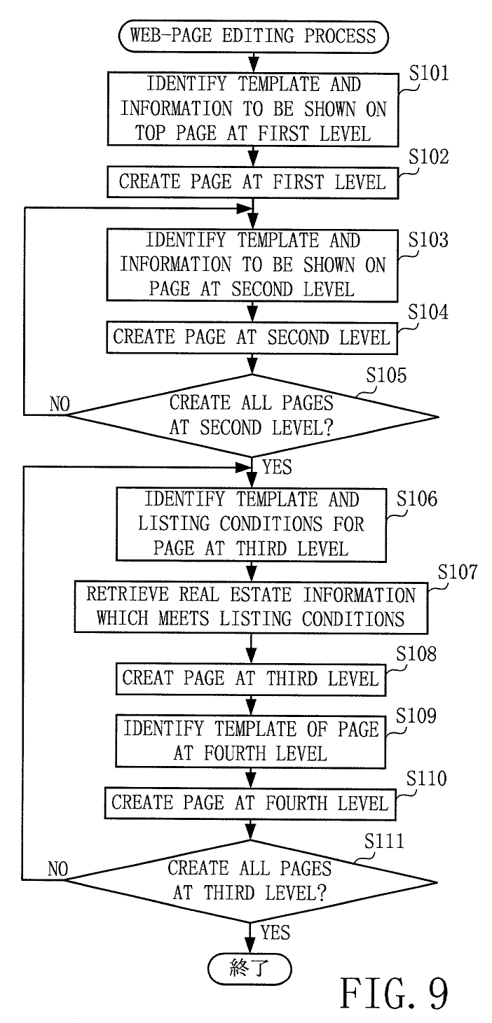

Upon completion of the setting of the to-be-shown information, the controller 15 of the Web page creator 2 carries out a Web-page editing process which is shown in FIG. 9. In performing this process for editing Web pages, the controller 15 is to create each Web page included in the group of Web pages.

The controller 15 retrieves the template selection information and input information data from the storage section 13, and identifies the template and to-be-shown information on the top page at the first level of the hierarchy (Step S101).

After this, the controller 15 retrieves data representing the identified template from the storage section 13. Subsequently, the controller 15 identifies tags, etc. specified by the retrieved template data, and incorporates the identified to-be-shown information in a predetermined position of the template. The controller 15 then creates a file (e.g. an HTML file) for displaying the top page (Step S102). This achieves in creating the top page at the first level of the hierarchy.

The controller 15 identifies the Web pages (the search page for rentals, the search page for buying/selling, and the Web page for company information) at the second level of hierarchy, based on the linking information stored in the storage section 13. The controller 15 retrieves the template selection information and input information data from the storage section 13, and identifies the template and to-be-shown information of one Web page of the Web pages at the second level of hierarchy (Step S103).

After this, the controller 15 retrieves the identified template data from the storage section 13. Subsequently, the controller 15 identifies tags specified by the retrieved template data, and incorporates the identified to-be-shown information in a predetermined position of the template. The controller 15 creates a file for displaying one Web page at the second level of hierarchy (Step S104). Then, one of the Web pages at the second level of hierarchy is thus created.

Subsequently, the controller 15 determines whether all files for displaying the Web pages at the second level of hierarchy are completed (Step S105).

In the case where it is determined that all files for displaying the Web pages at the second level of hierarchy are not completed (Step S105; NO), the controller 15 returns to the procedure of the step S103.

In the case where it is determined that all files for displaying the Web pages at the second level of hierarchy are completed (Step S105; YES), the controller 15 determines the listing page at the third level of hierarchy, based on the linking information stored in the storage section 13. The controller 15 retrieves the template selection information and listing conditions which are stored in the storage section 13. For one of the listing pages, the controller 15 identifies the specified template and the input listing conditions (Step S106).

After this, the controller 15 retrieves the identified template data from the storage section 13. Subsequently, the controller 15 retrieves real estate information which meets the listing conditions, from the storage section 13 (Step S107).

The controller 15 identifies tags specified by the retrieved template data, and incorporates the retrieved real estate information in a predetermined position of the template. Specifically, as illustrated in FIGS. 7A and 7B, the real estate information is incorporated between tags each indicating the beginning or end of real-estate information included in the listing page. In the case where there is an area for displaying images, the controller 15 converts image data included in the real estate information (data) into a predetermined form, and incorporates the converted data in the area for displaying images. The controller 15 creates a file for displaying a listing page at the third level of hierarchy (Step S108). Then, one listing page for listing real estate information is created.

After this, the controller 15 retrieves the template selection information stored in the storage section 13, and identifies a template for the detail description page at the fourth level of hierarchy (Step S109). Note that this detail description page is linked to the listing page which is created in the step S108.

The controller 15 retrieves the identified template data from the storage section 13. The controller 15 extracts detail information to be shown on the detail description page, from the real estate information retrieved in the step S107. The controller 15 identifies tags and the like specified by the retrieved template data, and incorporates the extracted detail description information in a predetermined position of the template. The controller 15 creates a file for displaying the detail description page to be linked to the listing page created in the step S108 (Step S110). By now, of the detail description pages at the fourth level of hierarchy, the detail description page to be linked to the listing page created in the step S108 is created.

After this, the controller 15 determines whether all files necessary for displaying the Web pages at the third level of hierarchy are created (Step S111).

In the case where it is determined that the files for displaying the entire Web pages at the third level of hierarchy are not completed (Step S111; NO), the controller 15 returns to the procedure of the step S106.

On the contrary, in the case where it is determined that the files for displaying the entire Web pages at the third level of hierarchy are completed (Step S111; YES), the Web-page editing process is completed.

Accordingly, each Web page included in the group of Web pages is thus created. As explained above, the pre-set information is incorporated in the pre-set template, thereby simply creating each Web page. Hence, the user of the Web page creator 2 can easily create Web pages without going through troublesome procedures. Since the Web pages are created based on the linking relationship specified by the linking information stored in the storage section 13, those entire Web pages can be created.

Upon completion of the Web-page editing process, the controller 15 uploads the files for displaying the Web pages created in the above Web-page editing process, to a predetermined server using FTP (File Transfer Protocol), etc. Hence, general users operate a computer, etc., to access this server through a network, thereby easily browsing the real estate information provided by various real estate companies.

The real estate information (“other company information”) stored in the storage section 13 is automatically updated, if the controller 15 accesses the real-estate information center 1 at predetermined intervals, retrieves the latest real estate information, and updates the information stored in the storage section 13. The “own information” stored in the storage section 13 is updated, if the user of the Web page creator 2 operates the input section 12 and inputs the latest information. The information contents to be shown on the Web pages are automatically updated, if the controller 15 carries out the above Web-page editing process at predetermined intervals. As described above, the controller 15 creates the Web pages using the linking information stored in the storage section 13. Thus, all necessary information can be updated when to update the information contents to be shown on Web pages.

The user of the Web page creator 2 activates the program for creating Web pages, likewise the above. On the template-setting display screen or shown-information setting display screen, the user can add, correct, and delete the information to be shown on Web pages.

The above-described setting of the template may be performed before or after the setting of the to-be-shown information. In other words, the setting of the template may be performed after the to-be-shown information is set. In this case, a template may be selected suitably for each piece of the to-be-shown information which has been set beforehand. In this case, a plurality of templates can be linked to each other and displayed on a single Web page.

The controller 15 accesses a Web page created by any other real estate company at predetermined intervals, retrieves the real estate information provided by this company on a network in a CSV (Comma Separated Value) format, for example, and adds the retrieved information to the real estate information stored in the storage section 13. Then, plenty of real estate information can be stored in the storage section 13, and thus enabling to meet various demands from general users.

The apparatus of the present invention can be realized by a general computer, without the need for a dedicated apparatus. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the apparatus of the present invention. The above program and data may be stored in a disk device or the like included in the server device on the Internet, embedded in a carrier wave, and the program and data embedded in the carrier wave may be downloaded into the computer so as to realize the apparatus of the present invention.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-296735 filed on Sep. 28, 2000, and including specification, claims, drawings and summary. The disclosure of the above Japanese Patent Application is incorporated herein by reference in its entirety.

What is claimed is:

1. A to-be-provided information creator, which creates at least one Web page showing at least one piece of real estate information to be provided through a network, said creator comprising:
a memory which stores the at least one piece of real estate information and at least one template for the at least one Web page; and
a page maker which creates the at least one Web page, by incorporating the at least one piece of real estate information stored in said memory into the at least one template stored in said memory.

2. The to-be-provided information creator according to claim 1, wherein:
said memory stores a plurality of pieces of real estate information including the at least one piece of real estate information; and
said page maker incorporates two or more pieces of real estate information included in the plurality of pieces of real estate information, into the at least one template, in such a manner that the plurality of pieces of real estate information are successively displayed in a list form on a single Web page.

3. The to-be-provided information creator according to claim 1, wherein
said memory stores a plurality of pieces of real estate information including the at least one piece of real estate information and a plurality of templates including the at least one template, and said creator further including:
a template selector which selects the at least one template for the at least one Web page, from the plurality of templates stored in said memory, in response to a request from a user of said to-be-provided information creator; and
an information selector which selects the at least one piece of real estate information from the plurality of pieces of real estate information stored in said memory, in response to a request from the user, and
wherein said page maker incorporates the at least one piece of real estate information selected by said information selector, into the at least one template selected by said template selector.

4. The to-be-provided information creator according to claim 2, wherein
said memory stores a plurality of templates including the at least one template, and said creator further including:
a template selector which selects the at least one template for the at least one Web page, from the plurality of templates stored in said memory, in response to a request from a user of said to-be-provided information creator; and
an information selector which selects the two or more pieces of real estate information, from the plurality of pieces of real estate information stored in said memory, in response to a request from the user, and
wherein said page maker incorporates the two or more pieces of real estate information selected by said information selector, into the at least one template selected by said template selector.

5. The to-be-provided information creator according to claim 3, wherein:
the at least one Web page to be created by said page maker includes a plurality of Web pages in a hierarchical structure;
said memory stores linking information for providing a linking relationship between high and low levels of the hierarchical structure; and
said page maker creates all Web pages included in the hierarchical structure, using the linking information.

6. The to-be-provided information creator according to claim 4, wherein:
the at least one Web page to be created by said page maker includes a plurality of Web pages in a hierarchical structure;
said memory stores linking information for providing a linking relationship between high and low levels of the hierarchical structure; and
said page maker creates all Web pages included in the hierarchical structure, using the linking information.

7. The to-be-provided information creator according to claim 5, further including:
an information retriever which retrieves real estate information shown on another Web page, from the another Web page through a network; and
an information storage unit which stores the information retrieved by said information retriever in said memory.

8. The to-be-provided information creator according to claim 6, further including:
an information retriever which retrieves information regarding real estate from another Web page through a network; and
an information storage unit which stores the information retrieved by said information retriever in said memory.

9. A method for creating at least one Web page showing at least one piece of real estate information to be provided through a network, said method comprising the steps of:
storing the at least one piece of real estate information and at least one template for the at least one Web page; and
creating the at least one Web page showing, by incorporating the at least one piece of real estate information into the at least one template.

10. The method according to claim 9, wherein:
said storing step includes a step of storing a plurality of pieces of real estate information including the at least one piece of real estate information; and
said creating step includes a step of incorporating two or more pieces of real estate information included in the plurality of pieces of real estate information, into the at least one template, in such a way that the plurality of pieces of real estate information are successively displayed in a list form on a single Web page.

11. The method according to claim 9, wherein
said storing step includes a step of storing a plurality of pieces of real estate information including the at least one real estate information and a step of storing a plurality of templates including the at least one template, and said method further including the steps of:
selecting the at least one template for the at least one Web page from the plurality of templates, in response to a request from a user; and
selecting the at least one piece of real estate information from the plurality of pieces of real estate information, in response to a request from the user, and
wherein said creating step includes a step of incorporating the selected at least one piece of real estate information into the selected at least one template.

12. The method according to claim 10 wherein
said storing step includes a step of storing a plurality of templates including the at least one template, and said method further including the steps of:
selecting the at least one template for the at least one Web page from the plurality of templates, in response to a request from a user; and
selecting two or more pieces of real estate information from the plurality of pieces of real estate information, in response to a request from the user, and
wherein said creating step includes a step of incorporating the selected two or more pieces of real estate information into the selected at least one template.

13. The method according to claim 11, wherein:
the at least one Web page to be created includes a plurality of Web pages in a hierarchical structure;
said method further includes a step of storing linking information for providing a linking relationship between high and low levels of the hierarchical structure; and
said creating step includes a step of creating all Web pages included in the hierarchical structure, using the linking information.

14. The method according to claim 12, wherein:
the at least one Web page to be created includes a plurality of Web pages in a hierarchical structure;
said method further includes a step of storing linking information for providing a linking relationship between high and low levels of the hierarchical structure; and
said creating step includes a step of creating all Web pages included in the hierarchical structure, using the linking information.

15. The method according to claim 13, further including the steps of:
retrieving a piece of real estate information shown on another Web page, from the another Web page through a network; and
storing the retrieved information.

16. The method according to claim 14, further including the steps of:
retrieving a piece of real estate information shown on another Web page, from the another Web page through a network; and
storing the retrieved information.

17. A program for controlling a computer to function as
a to-be-provided information creator which creates at least one Web page showing at least one piece of real estate information to be provided through a network, and said creator comprising:
a memory which stores the at least one piece of real estate information and at least one template for the at least one Web page; and
a page maker which creates the at least one Web page by incorporating the at least one piece of real estate information stored in said memory, into the at least one template.
